(19) United States
(12) Patent Application Publication
(10) Pub. No.: US 2008/0067164 A1
(43) Pub. Date: Mar. 20, 2008

(54) STAND FOR HOLDING SOLDERING IRON

(75) Inventor: SZU-WEI KUO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/769,729

(22) Filed: Jun. 28, 2007

(30) Foreign Application Priority Data
Sep. 15, 2006 (CN) 200610062680.5

(51) Int. Cl. B23K 3/03

(52) U.S. Cl. 219/242

(57) ABSTRACT

A stand configured for holding a soldering iron therein includes a base, and a supporting member extending slantingly and upwardly from the base. A reservoir is defined in one end of the base for receiving solder therein. A sponge holder sponge holder is defined in another end of the base for receiving a sponge. The supporting member defines a tube for receiving the soldering iron therein. When the soldering iron is holden in the tube of the supporting member, the tip of the soldering iron extends into the solder.

### BACKGROUND OF THE INVENTION

1. Field of the Invention

The present invention relates to a stand for holding soldering iron.

2. Description of Related Art

Currently, electronic components are electronically connected to circuit boards via soldering. Owing to susceptibility to oxidation, a tip of a soldering iron should be extended in solder when put away. Then the solder melted away, and finally the tip wiped with a sponge to remove any oxidants adhering to the tip when it's time to solder. However, the iron, the solder, and the sponge are usually put away or stored separately. Accordingly, there is a need for a simple, yet effective soldering iron stand, which reduces or inhibits air circulation about the bit when the iron is on stand-by, and which also provides a more permanent means for holding the soldering iron between uses. In conventional uses, structures of stands are usually complex. This makes the process unduly cumbersome and complicated.

What is needed is to provide a stand which easily holds the iron, the solder and the sponge, and is timesaving.

### SUMMARY OF THE INVENTION

In one embodiment, a stand configured for holding a soldering iron therein includes a base, and a supporting member extending slantingly and upwardly from the base. A reservoir is defined in one end of the base for receiving solder therein. A sponge holder is defined in another end of the base for receiving a sponge. The supporting member defines a tube for receiving the soldering iron therein. When the soldering iron is supportedly placed in the tube of the supporting member, the tip of the soldering iron extends into the solder.

Other advantages and novel features of the invention will become more apparent from the following detailed description when taken in conjunction with the accompanying drawings, in which:

### BRIEF DESCRIPTION OF THE DRAWINGS

FIG. 1 is an isometric view of a stand for holding a soldering iron in accordance with a preferred embodiment of the present invention;

FIG. 2 is a left side elevational view of FIG. 1

FIG. 3 is a bottom plan view of FIG. 1; and

FIG. 4 is a sectional view of the stand of FIG. 1 holding the soldering iron.

### DETAILED DESCRIPTION OF THE INVENTION

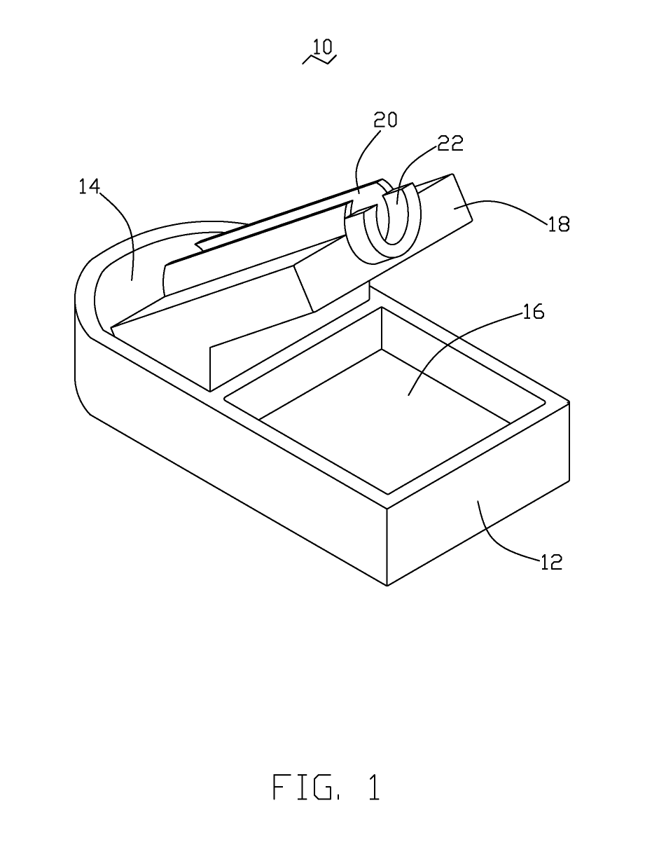

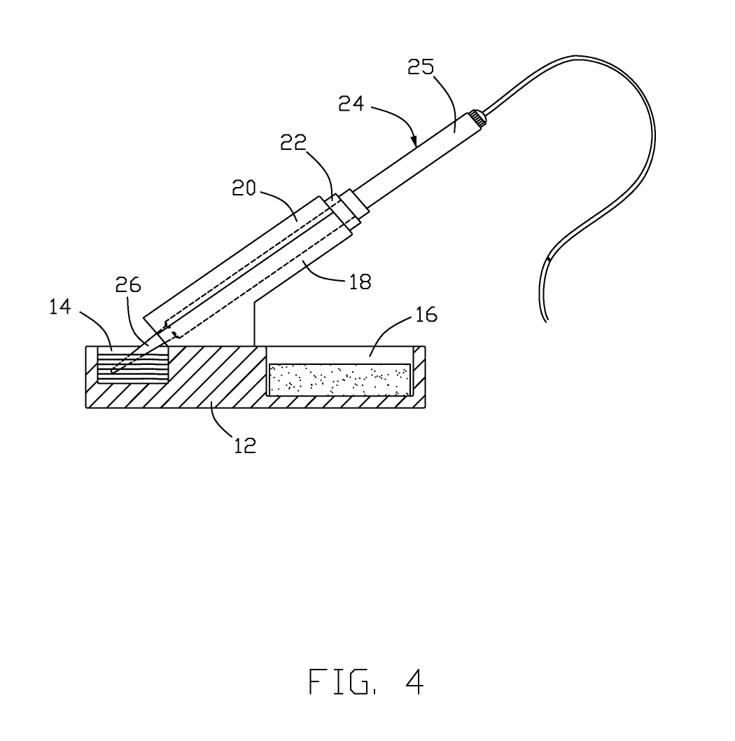

Referring to FIGS. 1 and 4, a stand 10 for holding a soldering iron 24 therein in accordance with a preferred embodiment of the present invention includes a base 12, and a supporting member 18 extending slantingly and upwardly from the base 12. The soldering iron 24 includes a metal tip 26 and an insulated handle 25.

The base 12 defines a reservoir 14 in one end thereof configured for receiving solder, and a sponge holder 16 in the other end thereof configured for receiving a sponge. In this embodiment, the sponge holder 16 is rectangular but other shapes may be used as desired. A partition wall separates the reservoir 14 from the sponge holder 16.

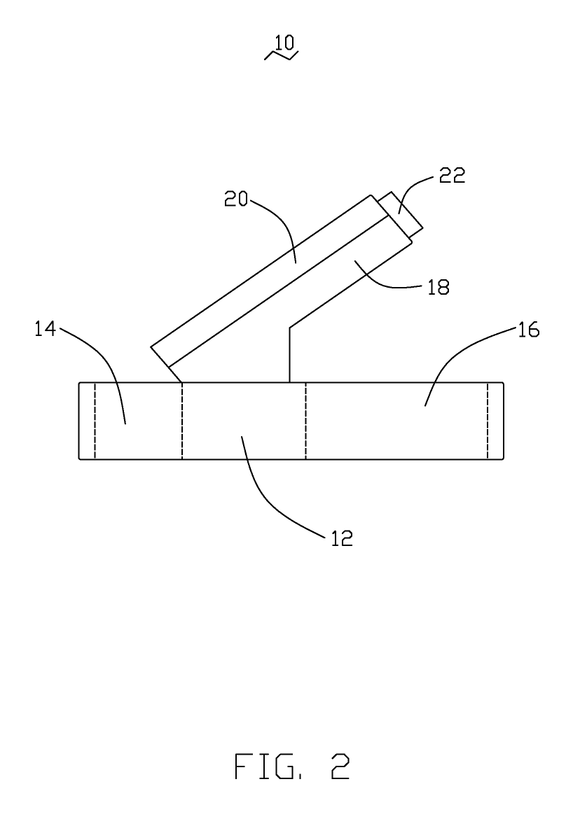

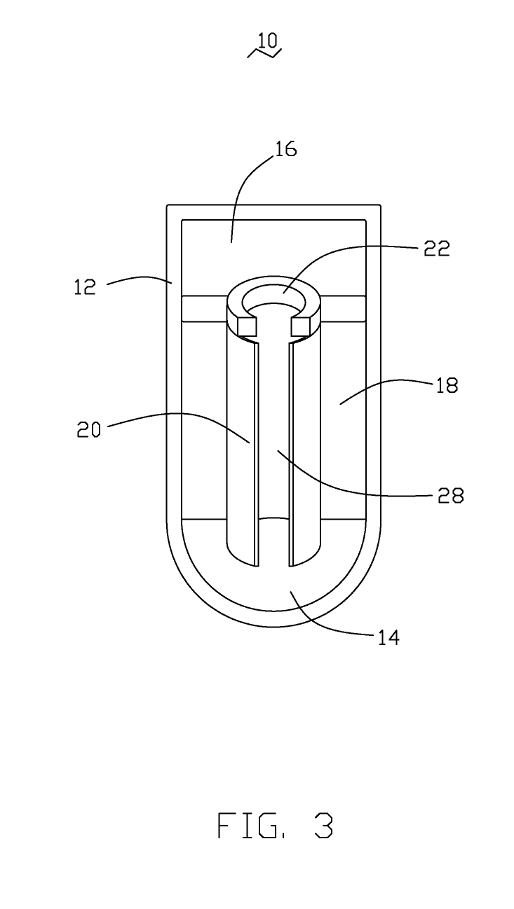

Referring also to FIGS. 2 and 3, the supporting member 18 is integrally and slantingly formed on the base 12, and is disposed between the reservoir 14 and the sponge holder 16, with the upper end hanging above the sponge holder 16.

The supporting member 18 includes a tube 20 formed lengthwise at an upper slanting surface thereof, with an elongated opening or slot 28 longitudinally defined in the upper surface of the tube 20, the slot 28 extending through the upper surface in a radial direction of the tube configured for facilitating rapid heat dissipation of the soldering iron 24. The upper end of the supporting member 18 forms an arcuate-shaped protrusion 22 around an entrance of the tube 20, for abutting one stop portion of the handle 25 to position the soldering iron 25 in the tube. The inner diameter of the tube 20 is greater than that of the arcuate-shaped protrusion 22 to thereby form a step between the tube 20 and the protrusion 22.

Before soldering, the soldering iron 24 is disposed in the tube 20 (see FIG. 4) with the tip 26 extending into the reservoir 14 partially submerged in solder (represented by horizontal lines but not labeled). When it's time to solder, the soldering iron 24 is pre-heated to melt the protective layer covering the tip 26 then removed from the tube 20, and the tip 26 is lightly tapped against the edge of the arcuate-shaped protrusion 22 to remove excess solder and then wiped with the sponge in the sponge holder 16 so as to remove any oxidants formed thereon. Then the soldering iron 24 is used normally.

After use, the soldering iron 24 is replaced in the tube 20 without a cooling down period. The hot tip 26 easily enters the solder, and the protective layer is formed by melting solder to cover the tip 26. Thus, the tip 26 is insulated from the air, for avoiding oxidation.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A stand configured for holding a soldering iron having a tip and an insulating handle, the stand comprising:
a base;
a reservoir defined in one end of the base for receiving solder;
a sponge holder defined in another end of the base for receiving a sponge to wipe the tip of the soldering iron; and
a supporting member extending slantingly and upwardly from the base between the reservoir and the sponge holder, the supporting member defining a tube for receiving the soldering iron therein;
wherein when the soldering iron is supportedly placed in the tube of the supporting member, the tip of the soldering iron extends into the reservoir.

2. The stand as claimed in claim 1, wherein the supporting member is integrally formed with the base, with an upper end hanging above the sponge holder.

3. The stand as claimed in claim 1, wherein a slot is longitudinally defined in an upper surface of the tube, the slot extending through the upper surface in a radial direction of the tube configured for facilitating rapid heat dissipation of the soldering iron.

4. The stand as claimed in claim 2, wherein the upper end of the supporting member includes an arcuate-shaped protrusion.

5. A stand configured for holding a soldering iron having a tip and an insulating handle, the stand comprising:
a base having a reservoir defined at one end thereof configured for receiving solder, a sponge holder defined at another end thereof configured for receiving a sponge to wipe the tip of the soldering iron, and a partition wall separating the reservoir from the sponge holder; and
a supporting member extending slantingly and upwardly from the partition wall of the base, the supporting member comprising a tube configured for receiving the soldering iron therein, the tube comprising a lower end facing the reservoir such that when the soldering iron is holden in the tube, the tip of the soldering iron extends into the reservoir.

6. The stand as claimed in claim 5, wherein an arcuate-shaped protrusion is formed at the supporting member adjacent an upper end of the tube configured for abutting one stop portion of the handle to position the soldering iron in the tube.

7. The stand as claimed in claim 5, wherein the inner diameter of the tube is greater than that of the arcuate-shaped protrusion to thereby form a step between the tube and the protrusion.
